(19) United States
(12) Patent Application Publication
(10) Pub. No.: US 2025/0063349 A1
(43) Pub. Date: Feb. 20, 2025

(54) SYSTEMS AND METHODS FOR X2 INTERFACE LINK DETECTION AND CONSTRUCTION

(71) Applicant: Rakuten Symphony, Inc., Tokyo (JP)

(72) Inventors: Manoj KUMAR, Tokyo (JP); Shubham GUPTA, Indore (IN); Rishi DAVDA, Tokyo (JP); Md Nurul AMIN, Tokyo (JP)

(21) Appl. No.: 18/263,697

(22) PCT Filed: Jun. 16, 2023
(86) PCT No.: PCT/US2023/025555

§ 371 Date: Jul. 31, 2023

(51) Int. Cl. H04W 12/06; H04W 76/10

(52) U.S. Cl. CPC H04W 12/06; H04W 76/10

(57) ABSTRACT

A network testing system includes a non-transitory computer readable medium configured to store instructions thereon, and a processor. The processor is configured to execute the instructions for receiving first reporting data associated with a master node for a first group of users. The processor is configured to execute the instructions for receiving second reporting data associated with a secondary node for a second group of users. The processor is configured to execute the instructions for determining whether an interface link between the master node and the secondary node has been established. The processor is configured to execute the instructions for establishing the interface link between the master node and the secondary node, in response to a determination that the interface link is not established.

### TECHNICAL FIELD

This description relates to a network system and a method of using a network system.

### BACKGROUND

Open Radio Access Network (O-RAN) is a technology that aims to create more open and interoperable cellular networks. O-RAN is an evolution of Radio Access Network (RAN) architecture. In some instances, O-RAN is controlled by a single operator.

The O-RAN architecture uses a distributed system of intelligent software agents, known as “white boxes,” to control the network. This allows for greater scalability and the ability to use a variety of different hardware components from different vendors.

O-RAN provides the ability to easily add new features and capabilities to the network by use of software-defined networking (SDN) and network functions virtualization (NFV) technologies.

O-RAN also helps to reduce costs for operators by allowing for the use of cheaper and more efficient hardware components. This helps to lower costs, which are potentially a barrier to the deployment of cellular networks.

Some elements of the O-RAN architecture include the Service Management and Orchestration Framework (SMO), RAN Intelligent Controller (RIC), O-Cloud, O-RAN central unit (O-CU or OCU), O-RAN distributed unit (O-DU or ODU), and O-RAN Radio unit (O-RU or ORU).

A control plane (C-plane) is responsible for signaling and control operations in the network by communicating with other network elements to coordinate and control various functions, such as call setup, mobility management and network resource allocation.

A user plane (U-plane) is responsible for delivering data and voice services to the end-users by transporting the actual user traffic between the radio access network and the core network.

A management plane (M-plane) provides centralized management and monitoring of the network elements, as well as configuration and maintenance of the network. The M-plane is responsible for monitoring the health and performance of the network, collecting statistics, and managing software upgrades and other network changes.

O-RAN provides a more secure network by separating the control plane and the data plane. This allows for greater flexibility in the deployment of security measures, such as firewalls, intrusion detection systems, and encryption.

### SUMMARY

A system includes a non-transitory computer readable medium configured to store instructions thereon. The system further includes a processor connected to the non-transitory computer readable medium. The processor is configured to execute the instructions for receiving first reporting data associated with a master node for a first group of users. The processor is configured to execute the instructions for receiving second reporting data associated with a secondary node for a second group of users. The processor is configured to execute the instructions for determining whether an interface link between the master node and the secondary node has been established. The processor is configured to execute the instructions for establishing the interface link between the master node and the secondary node, in response to a determination that the interface link is not established.

A method includes receiving first reporting data associated with a master node for a first group of users. The method further includes receiving second reporting data associated with a secondary node for a second group of users. The method further includes determining whether an interface link between the master node and the secondary node has been established. The method further includes establishing the interface link between the master node and the secondary node, in response to a determination that the interface link is not established.

A non-transitory computer readable medium configured to store instructions thereon. The instructions are configured to cause a processor to perform operations including receiving first reporting data associated with a master node for a first group of users. The instructions are configured to cause a processor to perform operations including receiving second reporting data associated with a secondary node for a second group of users. The instructions are configured to cause a processor to perform operations including determining whether an interface link between the master node and the secondary node has been established. The instructions are configured to cause a processor to perform operations including establishing the interface link between the master node and the secondary node, in response to a determination that the interface link is not established.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of an O-RAN system, according to at least some embodiments of the subject disclosure.

FIG. 2 is a schematic diagram of a network system, in accordance with some embodiments.

FIG. 3 is a schematic diagram of a network system, in accordance with some embodiments.

FIG. 4 is a schematic diagram of a portion of a network system, in accordance with some embodiments.

FIG. 5 is a sequence diagram of a method of using a network system, in accordance with some embodiments.

FIG. 6 is a table of measurement and reporting data, in accordance with some embodiments.

FIG. 7 is a table of measurement and reporting data, in accordance with some embodiments.

FIG. 8 is a block diagram of computer architecture in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

There are several instances wherein technology evolution creates inconsistencies or incompatibilities between previous capabilities and newly introduced capabilities. In some instances, technologies become stale, outdated, or become unable to provide support for newly introduced capabilities. In some instances, technologies are built with specific parameters or limitations that are unable to accommodate growth or unanticipated introduction of technology features.

In some instances, telecommunications, wireless, or cellular technology becomes outdated due to the rapid evolution or use of technology in the wireless or cellular technology area. As a result, rapid adaptability and new solutions are needed to accommodate rapidly changing broadband cellular network technology.

In some instances, a shift in technological capabilities or features is observable between fourth generation (4G)/Long-Term Evolution (LTE™) and fifth generation (5G) broadband cellular network technology. LTE™ sought to increase the capacity and speed of wireless data networks using new DSP (digital signal processing) techniques and modulations that previously were developed, and to redesign and simplify the network architecture to an internet protocol (IP) based system with reduced transfer latency, compared with the third generation (3G) broadband cellular network technology. Yet not only are 5G networks even faster than predecessor 4G networks, 5G possesses higher bandwidth and is able to connect a larger number of different devices, improving quality of internet services.

In some instances, some X2 interface linking, planning, or construction methods are inefficient or inaccurate in the setting of a changing technological landscape. In some instances, X2 interface linking, planning, or construction methods produce unexpected, poor performance, fail to efficiently establish X2 links, or inefficiently use resources. That is, a technological mismatch or deficiency in accommodating new technology has occurred.

In order to help reduce or solve these problems associated with technological evolution or shifts described, the current description includes systems and methods that accommodate evolving service resource configurations. The current description includes systems and methods that allow for more appropriate or more efficient identification of missing X2 links. The current description includes systems and methods that allow for more appropriate or more efficient X2 linking or construction. As a result, the current description includes systems and methods that are able to address deficiencies associated with technological mismatches, deficiencies, or outdated architecture.

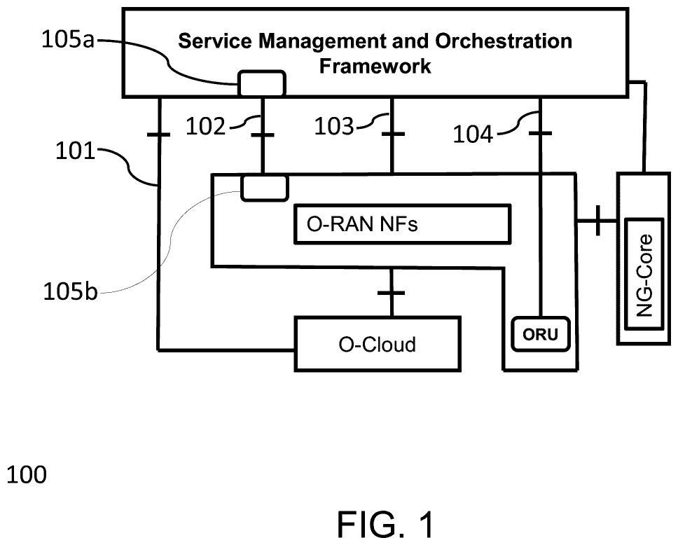

FIG. 1 is a schematic diagram of an O-RAN system 100, according to at least some embodiments of the subject disclosure.

O-RAN system 100 includes four interfaces A1 (102), O1 (103), Open Fronthaul M-plane interface (104) and O2 (101) that connect SMO (Service Management and Orchestration) 105 framework to O-RAN network functions and O-Cloud 106, a cloud computing platform including a collection of physical infrastructure nodes meeting O-RAN requirements to host relevant O-RAN functions. In some cases, O-RAN Network Functions 107 are VNFs (Virtualized Network Function) and/or PNFs (Physical Network Function) utilizing customized hardware Non-Real-Time RAN Intelligent Controller (Non-RT RIC) is shown at 107a, and Near-Real-Time RAN Intelligent Controller (Near-RT RIC) is shown at 107b. Near-RT RIC 107a is a logical function that enables near-real-time control and optimization of RAN elements and resources via fine-grained data collection and actions. Non-RT RIC 107b is a logical function within SMO 105 that drives the content carried across the A1 interface 102. Open Fronthaul M-plane interface (104) interfaces SMO 105 and O-RU 108. Mobile Core 109 is a bundle of functionality for authenticating devices, providing Internet (IP) connectivity, tracking user mobility, tracking subscriber usage, etc.

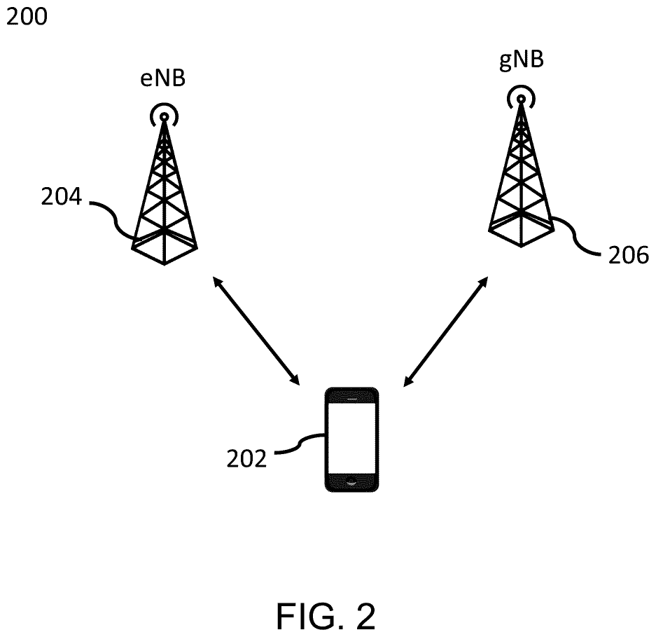

FIG. 2 is a schematic diagram of a network system 200, in accordance with some embodiments. The network system 200 includes user equipment (UE) 202. In some embodiments, UE 202 is a cellular device configured to communicate with a cellular network. In some embodiments, UE 202 is a cellular phone, mobile device, tablet, personal computer (PC), or mobile hotspot device. The network system 200 further includes Long Term Evolution (LTE) base station Evolved NodeB (eNB) 204. The network system 200 further includes fifth generation (5G) New Radio (NR) nodeB (gNB) 206.

The UE 202 is configured to communicate with eNB 204. In some embodiments, UE 202 is configured to receive downlink data from eNB 204. In some embodiments, UE 202 is configured to deliver or send uplink data to eNB 204. In some embodiments, eNB 204 is configured to deliver configuration data to UE 202. In some embodiments, eNB 204 is configured to receive configuration data from UE 202.

The UE 202 is configured to communicate with gNB 206. In some embodiments, UE 202 is configured to receive downlink data from gNB 206. In some embodiments, UE 202 is configured to deliver or send uplink data to gNB 206. In some embodiments, gNB 206 is configured to deliver configuration data to UE 202. In some embodiments, gNB 206 is configured to receive configuration data from UE 202.

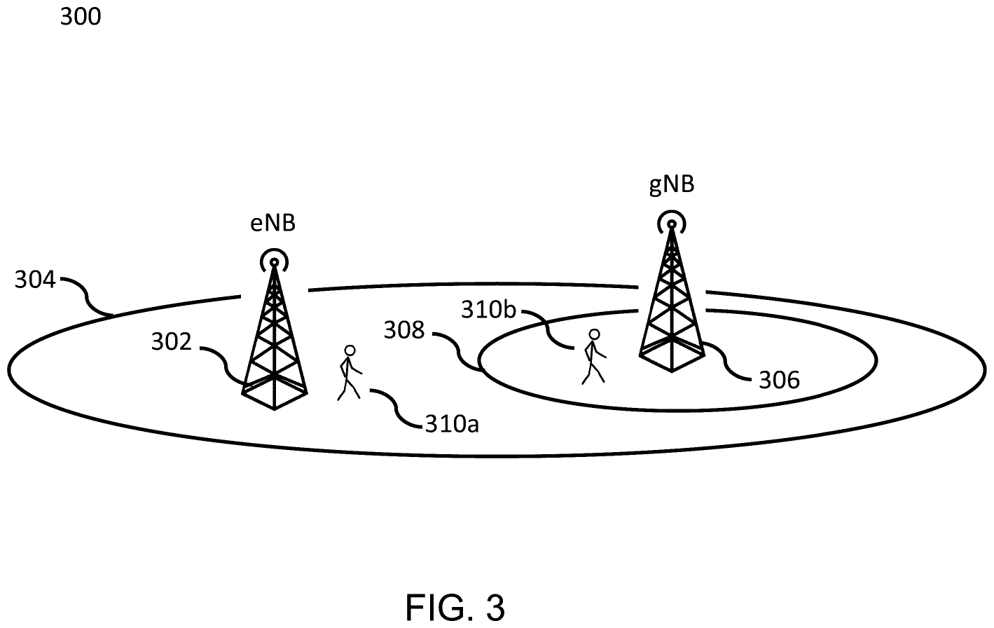

FIG. 3 is a schematic diagram of a network system 300, in accordance with some embodiments. The network system 300 includes Long Term Evolution (LTE) base station Evolved NodeB (eNB) 302. The eNB 302 provides a first coverage area 304.

The network system 300 further includes fifth generation (5G) New Radio (NR) (gNB) 304. The gNB 306 provides a second coverage area 308. In some nodeB embodiments, the second coverage area 308 is outside of first coverage area 304. In some embodiments, the second coverage area 308 is partially within first coverage area 304. In some embodiments, the second coverage area 308 is entirely within first coverage area 304.

The network system 300 is capable of servicing a first user at a first position 310a that is using a user equipment (UE). The first position 310a is within the first coverage area 304 and outside of the second coverage area 308. In some embodiments, UE is a cellular device configured to communicate with a cellular network. In some embodiments, UE is a cellular phone, mobile device, tablet, personal computer (PC), or mobile hotspot device.

The UE is configured to communicate with eNB 302. In some embodiments, UE is configured to receive downlink data from eNB 302. In some embodiments, UE is configured to deliver or send uplink data to eNB 302. In some embodiments, eNB 302 is configured to deliver configuration data to UE. In some embodiments, eNB 302 is configured to receive configuration data from UE.

The network system 300 is further capable of servicing the first user at a second position 310b. The second position 310b is within the first coverage area 304 and outside of the second coverage area 308. The UE is configured to communicate with gNB 306. In some embodiments, UE is configured to receive downlink data from gNB 306. In some embodiments, UE is configured to deliver or send uplink data to gNB 306. In some embodiments, gNB 306 is configured to deliver configuration data to UE. In some embodiments, gNB 306 is configured to receive configuration data from UE.

In some embodiments, the network system 300 is an EN-DC. EN-DC refers to Evolved Universal Terrestrial Radio Access Network (E-UTRAN) New Radio (NR) Dual Connectivity (DC) of LTE and 5G technologies. EN-DC allows for the gradual introduction of 5G technology, services, and data rates into the 4G/LTE landscape. EN-DC is therefore beneficial for 5G Non-Standalone (NSA) networks.

A user equipment (UE) that supports EN-DC is capable of connecting to both an LTE Master Node (MN) Evolved NodeB (eNB) and a Secondary Node (SN) fifth generation (5G) New Radio (NR) NodeB (gNB). This allows users and network providers to tap into 5G capabilities while avoiding some of the expenses associated with a full 5G core network.

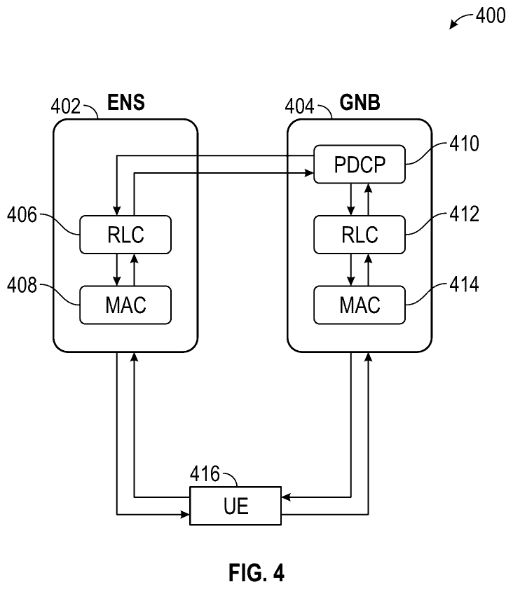

FIG. 4 is a schematic diagram of a portion of a network system 400, in accordance with some embodiments.

The network system 400 includes UE 216 in communication with eNB 402 and in communication with a gNB 404. In some embodiments, the network system 400 is usable in the network system 100 (FIG. 1). In some embodiments, the network system 400 is usable in a network system other than the network system 100 (FIG. 1). In some embodiments, the UE 416 communicates with eNB 402 and gNB 404 wirelessly. In comparison with the network system 100 (FIG. 1), eNB 402 and gNB 404 the network system 400 includes additional details for describing functionality and components of the network system 400.

The eNB 402 is configured to communicate with gNB 404 and gNB 404 is configured to communicate with eNB 402. In some embodiments, eNB 402 and gNB 404 work in coordination or concert to improve throughput for UE 416.

The network system 400 includes UE 416 configured to communicate with, and attached and admitted to, eNB 402. In some embodiments, UE 416 is configured to receive downlink data from eNB 402. In some embodiments, UE 416 is configured to deliver or send uplink data to eNB 402. In some embodiments, eNB 402 is configured to deliver configuration data to UE 402. In some embodiments, eNB 402 is configured to receive configuration data from UE 402. In some embodiments, eNB 402 is configured to provide or send configuration data including path configuration data such as a moreThanOneRLC information element (IE) and threshold data such as a ul-DataSplitThreshold IE. In some embodiments, a moreThanOneRLC IE includes a primary path. In some embodiments, a moreThanOneRLC IE or primary path includes an identifier such as a Logical Channel Identity (LCID) and an identifier such as a cell group identifier. In some embodiments, a moreThanOneRLC IE includes a threshold defining a cutoff to split uplink data between a primary path and a subordinate, or secondary, path such as a ul-DataSplitThreshold IE.

The eNB 402 includes Radio Link Control (RLC) 406 layer and Medium Access Control (MAC) 408 layer. RLC 406 is configured to communicate with MAC 408. In some embodiments, any of eNB 402, RLC 406, and MAC 408 are associated with a first LCID.

The network system 400 includes UE 416 configured to communicate with, and attached and admitted to, gNB 404. In some embodiments, UE 416 is configured to receive downlink data from gNB 404. In some embodiments, UE 416 is configured to deliver or send uplink data to gNB 404. In some embodiments, gNB 404 is configured to deliver configuration data to UE 402. In some embodiments, gNB 404 is configured to receive configuration data from UE 402. In some embodiments, gNB 404 is configured to provide or send configuration data including path configuration data such as a moreThanOneRLC information element (IE) and threshold data such as a ul-DataSplitThreshold IE. In some embodiments, a moreThanOneRLC IE includes a primary path. In some embodiments, a moreThanOneRLC IE or primary path includes an identifier such as a Logical Channel Identity (LCID) and an identifier such as a cell group identifier. In some embodiments, a moreThanOneRLC IE includes a threshold defining a cutoff to split uplink data between a primary path and a subordinate, or secondary, path such as a ul-DataSplitThreshold IE.

The gNB 404 includes Radio Link Control (RLC) 412 layer and Medium Access Control (MAC) 414 layer. RLC 412 is configured to communicate with MAC 414. In some embodiments, any of gNB 404, RLC 412, and MAC 414 are associated with a second LCID.

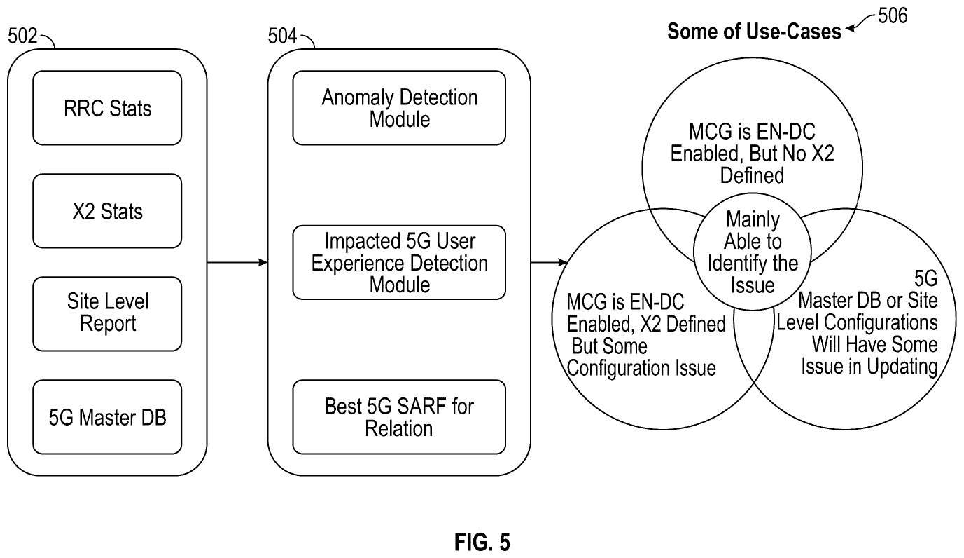

FIG. 5 is a sequence diagram of a method 500 of using a network system, in accordance with some embodiments. The method 500 is usable by a network system in order to help recognize missing X2 links or X2 link opportunities and to efficiently establish X2 links accordingly. By identifying anomalies, the method 500 helps to identify X2 link opportunities or existing service gaps. In some embodiments, the method 500 is able to be executed by the network system 100 (FIG. 1), the network system 200 (FIG. 2), the network system 300 (FIG. 3), or the network system 400 (FIG. 4). In some embodiments, the method 500 is able to be executed by a network system other than the network system 100 (FIG. 1), the network system 200 (FIG. 2), the network system 300 (FIG. 3), or the network system 400 (FIG. 4).

In operation 502, data from various sources is aggregated and stored. In some embodiments, data includes RRC related data or statistics (“RRC Stats”). In some embodiments, data includes X2 configuration related data or statistics (“X2 Stats”). In some embodiments, data includes site level reports. In some embodiments, data includes 5G related data such as 5G connection, service, or user data, (“5G Master DB”). In some embodiments, data includes measurement data. In some embodiments, data includes some or all data found in measurement reports. In some embodiments, data includes some or all data found in 4G, LTE, or 5G measurement reports. In some embodiments, measurement data includes signal measurement data of 4G, LTE, or 5G signals.

In some embodiments, a UE includes three defined Radio Resource Control (RRC) states, an RRC_IDLE state, an RRC_INACTIVE state, and an RRC_CONNECTED state. In some embodiments, an RRC connection establishment procedure is carried out for a UE and causes the UE to enter an RRC_CONNECTED state or mode. In some embodiments, an RRC_CONNECTED UE is configured by a network to perform measurements using a measurement configuration.

In some embodiments, an RRC_CONNECTED UE derives measurement results from a cell, such as a serving cell. In some embodiments, an RRC_CONNECTED UE derives measurement results from a cell, such as a neighboring cell. In some embodiments, an RRC_CONNECTED UE measures one or more beams associated with a cell. In some embodiments, an RRC_CONNECTED UE reports measurement information or data. In some embodiments, an RRC_CONNECTED UE reports measurement information or data to a base station. In some embodiments, an RRC_CONNECTED UE reports measurement information or data to an eNB. In some embodiments, an RRC_CONNECTED UE reports measurement information or data to a gNB. In some embodiments, an RRC_CONNECTED UE reports measurement information or data to a primary node. In some embodiments, an RRC_CONNECTED UE reports measurement information or data to a secondary node. In some embodiments, an RRC_CONNECTED UE reports measurement information or data on a per beam basis. In some embodiments, an RRC_CONNECTED UE reports measurement information or data on a per beam basis based on a network configuration.

In some embodiments, data includes event data. In some embodiments, data includes RRC event data.

In some embodiments, event data includes data associated with events when measurement data or results of a serving cell become greater than a threshold. In some embodiments, event data includes data associated with events when measurement data or results of a serving cell, less a hysteresis parameter, become greater than a threshold.

In some embodiments, event data includes data associated with events when measurement data or results of a serving cell become worse than a threshold. In some embodiments, event data includes data associated with events when measurement data or results of a serving cell, plus a hysteresis parameter, become greater than a threshold.

In some embodiments, event data includes data associated with events when measurement data or results of a neighboring cell become greater than a threshold. In some embodiments, event data includes data associated with events when measurement data or results of a neighboring cell, less a hysteresis parameter, become greater than a threshold.

In some embodiments, event data includes data associated with events when measurement data or results of a neighboring cell become worse than a threshold. In some embodiments, event data includes data associated with events when measurement data or results of a neighboring cell, plus a hysteresis parameter, become greater than a threshold.

In some embodiments, event data includes data associated with events when measurement data or results of an inter-RAT (Radio Access Technology) neighboring cell become greater than a threshold. In some embodiments, event data includes data associated with events when measurement data or results of an inter-RAT neighboring cell, less a hysteresis parameter, become greater than a threshold.

In some embodiments, event data includes data associated with events when measurement data or results of an inter-RAT neighboring cell become worse than a threshold. In some embodiments, event data includes data associated with events when measurement data or results of an inter-RAT neighboring cell, plus a hysteresis parameter, become greater than a threshold.

In some embodiments, a UE in an RRC_CONNETCED state maintains a measurement object list, a reporting configuration list, and a measurement identities list.

In some embodiments, a UE transfers measurement results or reports to the network. In some embodiments, a UE transfers serving cell measurement results or reports to the network. In some embodiments, a UE transfers neighboring cell measurement results or reports to the network.

In some embodiments, a network receives measurement reports and data from a first set of UEs served by, or associated with, a first eNB. In some embodiments, a first eNB is a primary node. In some embodiments, a network receives measurement reports and data from a second set of UEs served by, or associated with, a first gNB. In some embodiments, a first gNB is a serving gNB. In some embodiments, a first gNB is a neighboring gNB. In some embodiments, a first gNB is a secondary node. In some embodiments, none of the second set of UEs are within the first set of UEs. In some embodiments, some of the second set of UEs are within the first set of UEs. In some embodiments, all of the second set of UEs are within the first set of UEs. In some embodiments, a service or coverage area of the first gNB is within the service or coverage area of the first eNB. In some embodiments, the measurement reports include 4G measurement reports. In some embodiments, the measurement reports include LTE measurement reports. In some embodiments, the measurement reports include 5G measurement reports.

In operation 504, a data analysis process is carried out. In some embodiments, the data analysis process includes executing an algorithm. In some embodiments, the data analysis process includes executing an algorithm using some or all of the data or data types described herein, such as the data in or from measurement reports. In some embodiments, the data analysis process includes determining one or more anomalies using an anomaly detection module. In some embodiments, the data analysis process includes determining one or more impacted users or user experiences using an impacted user experience detection module. In some embodiments, the data analysis process includes determining one or more impacted 5G users or user experiences using an impacted 5G user experience detection module. In some embodiments, the data analysis process includes determining an inability to use 5G service. In some embodiments, the data analysis process includes determining a best 5G service area, node, or gNB for handover, connection, or attachment for one or more UEs. In some embodiments, the data analysis process includes determining or identifying one or more gNBs that are suited to service a particular area or UE. In some embodiments, the particular area is an area associated with, or nearby to, an eNB. In some embodiments, the eNB is an eNB that a particular UE is attached to or being serviced by.

### Fingerprint/Unique Key/Tagging

In some embodiments, a fingerprint, unique key, or tag is determined, assembled, or created during a data analysis process. In some embodiments, measurement reports include various data elements or identifiers associated with a respective reporting UE corresponding to each data item, entry, or member. In some embodiments, measurement reports include a cell id for a reporting UE for each data item, entry, or member. In some embodiments, measurement reports include an International Mobile Subscriber Identity (IMSI) corresponding to a reporting UE for each data item, entry, or member. In some embodiments, measurement reports include an E-UTRAN Cell Global Identifier (ECGI) for a reporting UE for each data item, entry, or member. In some embodiments, measurement reports include a Physical Cell ID, such as a neighboring physical NR cell (NBR_NR_PCI) for an eNB or reporting UE for each data item, entry, or member. In some embodiments, measurement reports include a frequency corresponding to a reporting UE for each data item, entry, or member. In some embodiments, some or all of the aforementioned data items are accessed or aggregated from a local source. In some embodiments, some or all of the aforementioned data items are accessed or aggregated from a remote source. In some embodiments, some or all of the aforementioned data items are accessed or aggregated from a local and remote source.

In some embodiments, one or more data elements or identifiers according to embodiments herein are combined or used together to uniquely identify a UE from which a measurement report data item or member originates, or to uniquely identify a measurement report data item or data member. In some embodiments, one or more identifiers according to embodiments herein are combined or used together to produce or create a key. In some embodiments, one or more identifiers according to embodiments herein are combined to produce or create a fingerprint. In some embodiments, the number of identifiers combined to produce or create a fingerprint is minimized. In some embodiments, some or all of an IMSI, ECGI, NBR_NR_PCI, and a frequency are combined or used together to create an identifier, fingerprint, or key.

### Traffic/Service Gaps, Missing X2 Links and X2 Link Opportunities

In some embodiments, traffic/service gaps, missing X2 links, or X2 link opportunities are determined or identified during a data analysis process. In some cases, a useful X2 link is not yet defined. For example, in some cases, during a planning or configuration phase, an X2 link between an eNB and a gNB was not defined or missed. In some cases, handover of a UE from the eNB to the gNB is missed, or unable to occur, as a function of no defined X2 link. In some cases, handover of many UEs from the eNB to the gNB is missed as a function of no defined X2 link.

### Data Extraction

In some embodiments, data related to measurement reports or associated events are identified, compared, or analyzed to identify missing X2 links or X2 link opportunities. In some embodiments, data related to measurement reports or associated events are identified, compared, or analyzed at an eNB or other base station. In some embodiments, data related to measurement reports or associated events are identified, compared, or analyzed outside of an eNB. In some embodiments, data related to measurement reports or associated events are identified, compared, or analyzed at a cloud location or by a cloud processor or server. In some embodiments, data from measurement reports are identified, compared, or analyzed to identify missing X2 links or X2 link opportunities. In some embodiments, data from measurement reports for signals at UEs associated with an eNB are identified, compared, or analyzed to identify missing X2 links or X2 link opportunities. In some embodiments, data from measurement reports for signals at UEs associated with a gNB are identified, compared, or analyzed to identify missing X2 links or X2 link opportunities. In some embodiments, data from measurement reports for signals at UEs associated with eNB and a gNB are identified, compared, or analyzed to identify missing X2 links or X2 link opportunities. In some embodiments, data from measurement reports for signals at particular UEs associated with an eNB and a gNB are identified, compared, or analyzed to identify missing X2 links or X2 link opportunities. For example, in some embodiments, identification of signal or measurement data at a particular UE associated with an eNB and a gNB indicates an X2 link is missing or X2 link opportunity when an X2 link is not defined between the eNB and the gNB or a handover has not occurred. In some embodiments, identification of signal or measurement data at many particular UEs associated with an eNB and a gNB indicates an X2 link is missing or X2 link opportunity when an X2 link is not defined between the eNB and the gNB or handovers have not occurred. In some embodiments, identification of signal or measurement data at a threshold number of particular UEs associated with an eNB and a gNB indicates an X2 link is missing or X2 link opportunity when an X2 link is not defined between the eNB and the gNB or handovers have not occurred.

### Learning Model and Features

In some embodiments, some or all data elements extracted are input into a model. In some embodiments, some or all data elements extracted are input into a learning model. In some embodiments, some or all data elements extracted are input into an unsupervised learning model. In some embodiments, some or all data elements extracted are used as features in an unsupervised learning model. In some embodiments, a number of measurement reports is used as a feature in an unsupervised learning model. In some embodiments, a number of UEs is used as a feature in an unsupervised learning model. In some embodiments, a number of UEs providing measurement reports is used as a feature in an unsupervised learning model. In some embodiments, a number of UEs providing 4G measurement reports is used as a feature in an unsupervised learning model. In some embodiments, a number of UEs providing LTE measurement reports is used as a feature in an unsupervised learning model. In some embodiments, a number of UEs providing 5G measurement reports is used as a feature in an unsupervised learning model. In some embodiments, a number of unique UEs providing measurement reports is used as a feature in an unsupervised learning model. In some embodiments, a number of unique UEs providing 4G measurement reports is used as a feature in an unsupervised learning model. In some embodiments, a number of unique UEs providing LTE measurement reports is used as a feature in an unsupervised learning model. In some embodiments, a number of unique UEs providing 5G measurement reports is used as a feature in an unsupervised learning model. In some embodiments, a difference or delta between two or more sets of measurement reports or data lists is used as a feature in an unsupervised learning model. In some embodiments, a difference or delta between two or more sets of measurement reports or data lists is used as a feature in an unsupervised learning model. In some embodiments, a difference or delta between a number of UEs associated with two or more sets of measurement reports or data lists is used as a feature in an unsupervised learning model. In some embodiments, a difference or delta between a number of unique UEs associated with two or more sets of measurement reports or data lists is used as a feature in an unsupervised learning model. In some embodiments a number of measurement reports or number of unique UEs associated with a measurement reports list indicates a number of UEs within a service or coverage area of an eNB. In some embodiments a number of measurement reports or number of unique UEs associated with a measurement reports list indicates a number of UEs within a service or coverage area of a gNB. In some embodiments, a number of UEs indicating to be within a service or coverage area of an eNB and a gNB indicates an X2 link opportunity between the eNB and gNB. In some embodiments, a number of UEs exceeding a threshold number indicating to be within a service or coverage area of an eNB and a gNB indicates an X2 link opportunity between the eNB and gNB. In some embodiments, a number of UEs indicating to be within a service or coverage area of an eNB and a gNB between which no X2 link is defined indicates an anomaly. In some embodiments, a number of UEs exceeding a threshold number indicating to be within a service or coverage area of an eNB and a gNB between which no X2 link is defined indicates an anomaly.

### Clustering

In some embodiments, a clustering method or algorithm is executed using some or all data elements. In some embodiments, a clustering method or algorithm includes K-means clustering. In some embodiments, a clustering method or algorithm includes agglomerative clustering. In some embodiments, a clustering method or algorithm includes mean-shift clustering.

In operation 506, an output is provided from the data analysis process. In some embodiments, the output includes one or more anomalies. In some embodiments, the output includes one or more anomalies indicating a traffic/service gap, inadequacy, or optimization opportunity. In some embodiments, the output includes one or more anomalies indicating a configuration gap, inadequacy, or optimization opportunity. In some embodiments, the output includes one or more anomalies indicating an X2 link configuration gap, inadequacy, or optimization opportunity. In some embodiments, the output includes one or more recommendations. In some embodiments, the output includes one or more X2 link addition recommendations. In some embodiments, the output includes one or more X2 link addition recommendations where EN-DC is enabled. In some embodiments, the output is delivered to one or more users or stakeholders. In some embodiments, the output is delivered to one or more users or stakeholders in one or more data files or payloads. In some embodiments, the output is delivered to one or more users or stakeholders that are associated with particular anomalies. For example, in some embodiments, an output associated with an anomaly associated with a particular eNB is delivered to an owner or service provider associated with the eNB or geographic location associated with the eNB. One or ordinary skill in the art would understand that the processes described herein are possible for multiple anomalies, multiple outputs, and multiple stakeholders. Accordingly, delivery of tailored recommendations to multiple stakeholders is possible.

One of ordinary skill in the art would understand that additional operations are possible within method 500 in some embodiments. For example, in some embodiments, the method 500 further includes providing multiple recommendations to multiple stakeholders. In some embodiments, an order of operations of the method 500 is changed. For example, in some embodiments the analyses steps of operation 504 are reordered. In some embodiments, at least one element of the method 500 is omitted. For example, in some embodiments, one or more of the analyses steps in operation 504 is omitted.

Utilizing the method 500 helps to ensure that the network system is optimized. As a result, the network system is more likely to function as intended or more optimally.

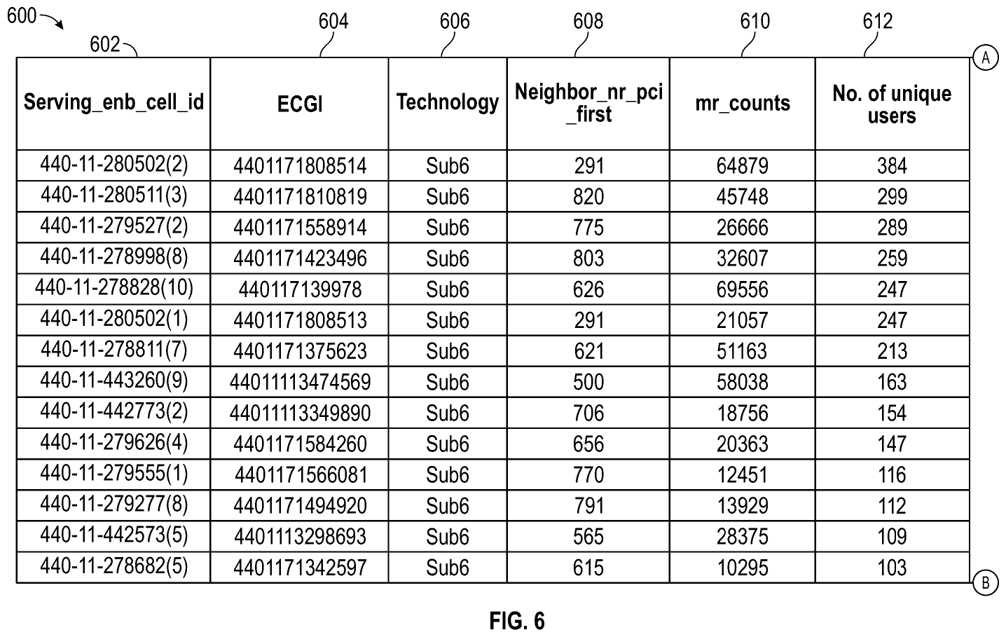

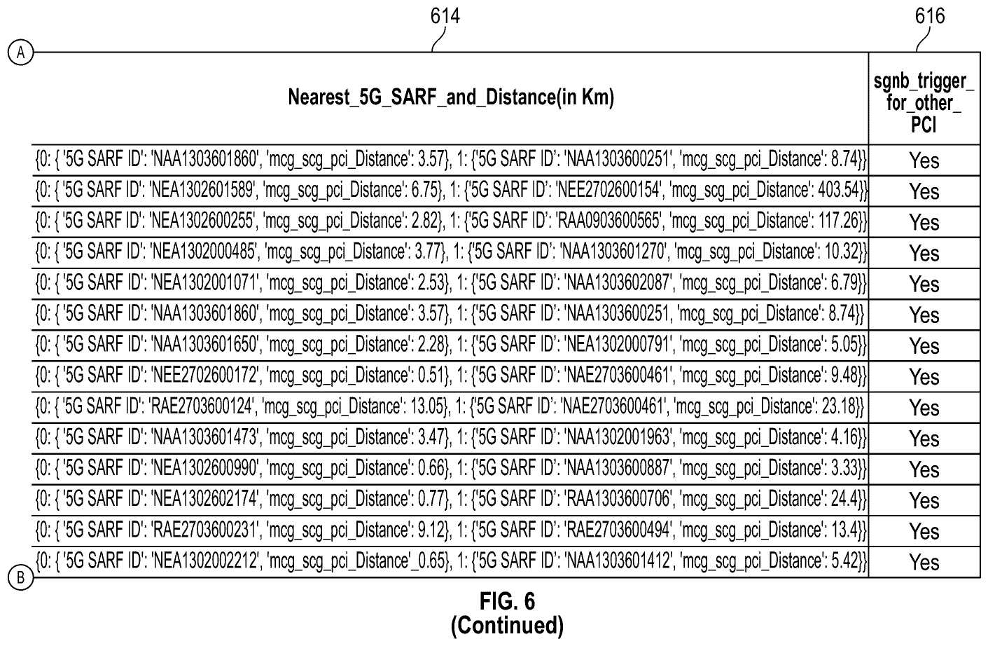

FIG. 6 is a table of measurement and reporting data 600, in accordance with some embodiments.

Measurement and reporting data 600 includes, for each row, a serving eNB cell ID 602, an ECGI 604, a technology type 606, a neighboring NR PCI 608, a measurement reports count 610, a number of unique users 612, a nearest 5G site information (SARF) and distance 614, and an SgNB trigger value 616. In some embodiments, some or all of the measurement reporting data 600 is used in a data extraction or analysis process, according to embodiments herein.

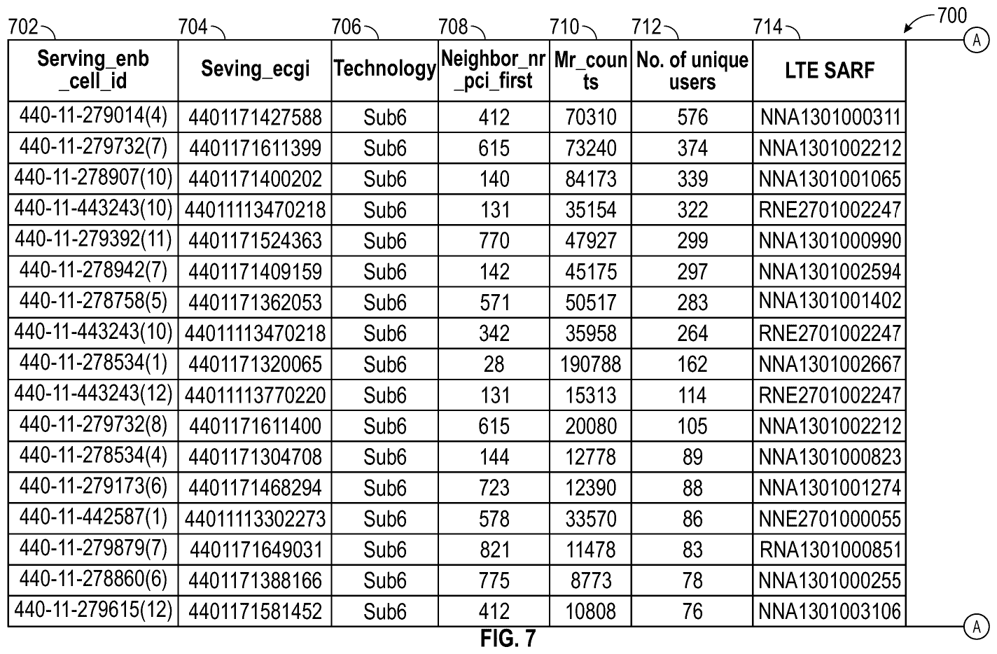

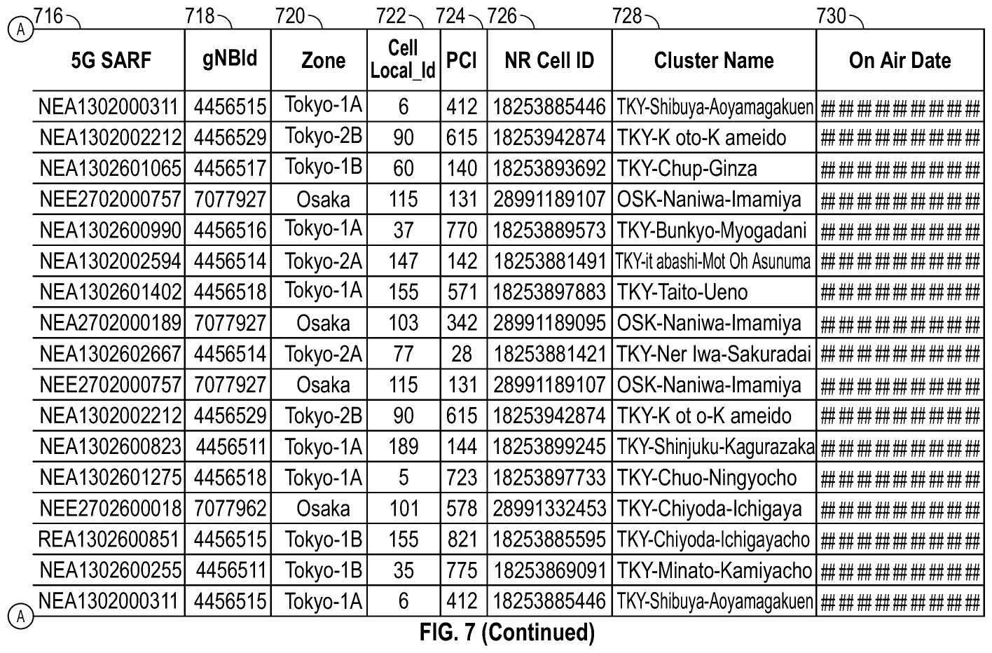

FIG. 7 is a table of measurement and reporting data 700, in accordance with some embodiments.

Measurement and reporting data 700 includes, for each row, a serving eNB cell ID 702, an ECGI 704, a technology type 706, a neighboring NR PCI 708, a measurement reports count 710, a number of unique users 712, an LTE SARF 714, a 5G SARF 716, a gNB ID 718, a zone 720, a local cell ID 722, a PCI 724, an NR cell ID 726, a cluster name 728, and an on air date 730. In some embodiments, some or all of the measurement reporting data 700 is used in a data extraction or analysis process, according to embodiments herein.

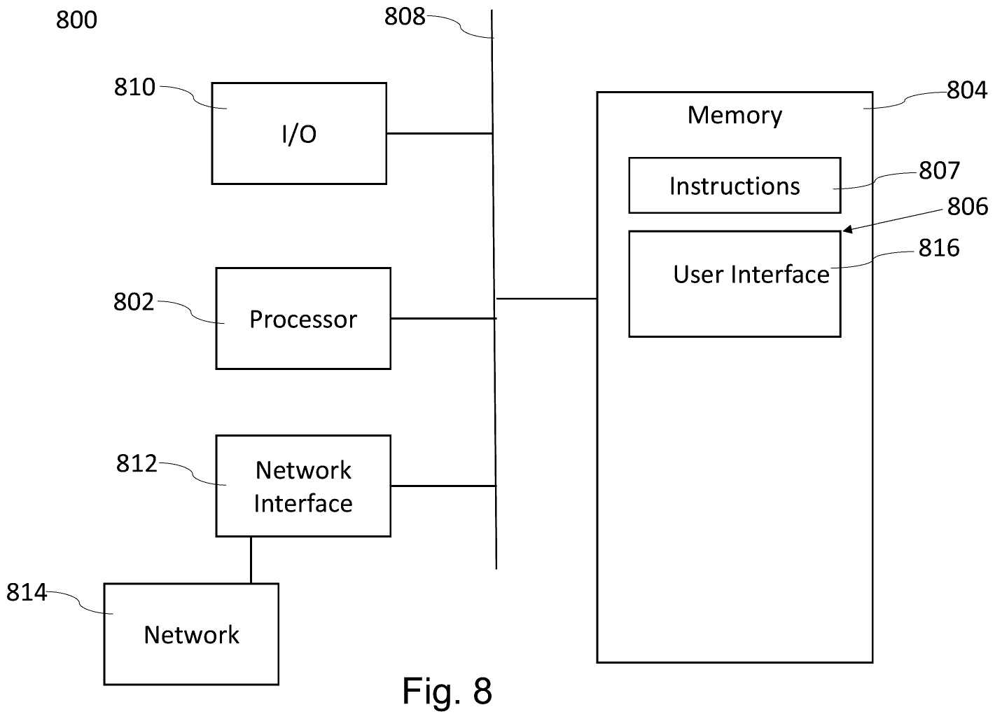

FIG. 8 is a block diagram of computer architecture 800 in accordance with some embodiments.

Computer architecture 800 includes a hardware processor 802 and a non-transitory, computer readable storage medium 804 encoded with, i.e., storing, the computer program code 806, i.e., a set of executable instructions. Computer readable storage medium 804 is also encoded with instructions 807 for interfacing with external devices. The processor 802 is electrically coupled to the computer readable storage medium 804 via a bus 808. The processor 802 is also electrically coupled to an I/O interface 810 by bus 808. A network interface 812 is also electrically connected to the processor 802 via bus 808. Network interface 812 is connected to a network 814, so that processor 802 and computer readable storage medium 804 are capable of connecting to external elements via network 814. The processor 802 is configured to execute the computer program code 806 encoded in the computer readable storage medium 804 in order to cause computer architecture 800 to be usable for performing a portion or all of the operations as described herein.

In some embodiments, the processor 802 is a central processing unit (CPU), a multi-processor, a distributed processing system, an application specific integrated circuit (ASIC), or a suitable processing unit.

In some embodiments, the computer readable storage medium 804 is an electronic, magnetic, optical, electromagnetic, infrared, or a semiconductor system (or apparatus or device). For example, the computer readable storage medium 604 includes a semiconductor or solid-state memory, a magnetic tape, a removable computer diskette, a random access memory (RAM), a read-only memory (ROM), a rigid magnetic disk, or an optical disk. In some embodiments using optical disks, the computer readable storage medium 804 includes a compact disk-read only memory (CD-ROM), a compact disk-read/write (CD-R/W), or a digital video disc (DVD).

In some embodiments, the storage medium 804 stores the computer program code 606 configured to cause computer architecture 800 to perform a portion or all of the operations as described herein. In some embodiments, the storage medium 804 also stores information needed for performing a portion or all of the operations as described herein as well as information generated during performing a portion or all of the operations as described herein, such as a user interface parameter 816.

In some embodiments, the storage medium 804 stores instructions 607 for interfacing with external devices. The instructions 807 enable processor 802 to generate instructions readable by the external devices to effectively implement a portion or all of the operations as described herein.

Computer architecture 800 includes I/O interface 810. I/O interface 810 is coupled to external circuitry. In some embodiments, I/O interface 810 includes a keyboard, keypad, mouse, trackball, trackpad, or cursor direction keys for communicating information and commands to processor 802.

Computer architecture 800 also includes network interface 812 coupled to the processor 802. Network interface 812 allows computer architecture 600 to communicate with network 814, to which one or more other computer systems are connected. Network interface 812 includes wireless network interfaces such as BLUETOOTH, WIFI, WIMAX, GPRS, or WCDMA; or wired network interface such as ETHERNET, USB, or IEEE-1394. In some embodiments, a portion or all of the operations as described herein, and information are exchanged between different computer architecture 800 via network 814.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, or processors supplied with computer-readable instructions stored on computer-readable media. In at least some embodiments, dedicated circuitry includes digital or analog hardware circuits and include integrated circuits (IC) or discrete circuits. In at least some embodiments, programmable circuitry includes reconfigurable hardware circuits including logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network or a wireless network. In at least some embodiments, the network includes copper transmission cables, optical transmission fibers, wireless transmission, routers, firewalls, switches, gateway computers or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the subject disclosure.

While embodiments of the subject disclosure have been described, the technical scope of any subject matter claimed is not limited to the above-described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by ‘prior to,’ ‘before,’ or the like and as long as the output from a previous process is not used in a later process. Even if the process flow is described using phrases such as ‘first’ or ‘next’ in the claims, embodiments, or diagrams, such a description does not necessarily mean that the processes must be performed in the described order.

### Supplemental Note 1

A system includes a non-transitory computer readable medium configured to store instructions thereon. The system further includes a processor connected to the non-transitory computer readable medium. The processor is configured to execute the instructions for receiving first reporting data associated with a master node for a first group of users. The processor is configured to execute the instructions for receiving second reporting data associated with a secondary node for a second group of users. The processor is configured to execute the instructions for determining whether an interface link between the master node and the secondary node has been established. The processor is configured to execute the instructions for establishing the interface link between the master node and the secondary node, in response to a determination that the interface link is not established.

### Supplemental Note 2

In some embodiments, the processor of Supplemental Note 1 wherein the interface link includes an X2 interface link.

### Supplemental Note 3

In some embodiments, the system of any of Supplemental Notes 1 and 2 wherein the first reporting data includes Long Term Evolution (LTE) or fourth generation (4G) measurement data and the second reporting data includes fifth generation (5G) measurement data.

### Supplemental Note 4

In some embodiments, the processor of any of Supplemental Notes 1-3 is further configured to execute the instructions for: determining, using an unsupervised machine learning model, one or more X2 link opportunities.

### Supplemental Note 5

In some embodiments, the processor of any of Supplemental Notes 1-4 is further configured to execute the instructions for: creating a fingerprint to uniquely identify data in the first reporting data.

### Supplemental Note 6

In some embodiments, the system any of Supplemental Notes 1-5 wherein the master node is capable of providing service for a first coverage area, and the secondary node is capable of providing service for a second coverage area within the first coverage area.

### Supplemental Note 7

In some embodiments, the processor any of Supplemental Notes 1-7 is further configured to execute the instructions for: comparing first data elements from the first reporting data corresponding to a first fingerprint with second data elements from the second reporting data corresponding to the first fingerprint.

### Supplemental Note 8

A method includes receiving first reporting data associated with a master node for a first group of users. The method further includes receiving second reporting data associated with a secondary node for a second group of users. The method further includes determining whether an interface link between the master node and the secondary node has been established. The method further includes establishing the interface link between the master node and the secondary node, in response to a determination that the interface link is not established.

### Supplemental Note 9

The method of Supplemental Note 8, wherein the interface link includes an X2 interface link.

### Supplemental Note 10

The method of Supplemental Note 8 or 9 wherein the first reporting data includes Long Term Evolution (LTE) or fourth generation (4G) measurement data and the second reporting data includes fifth generation (5G) measurement data.

### Supplemental Note 11

The method of any of Supplemental Notes 8-10 further including: determining, using an unsupervised machine learning model, one or more X2 link opportunities.

### Supplemental Note 12

The method of any of Supplemental Notes 8-11, further including: creating a fingerprint to uniquely identify data in the first reporting data.

### Supplemental Note 13

The method of any of Supplemental Notes 8-12, wherein the master node is capable of providing service for a first coverage area, and the secondary node is capable of providing service for a second coverage area within the first coverage area.

### Supplemental Note 14

The method of any of Supplemental Notes 8-13, further including: comparing first data elements from the first reporting data corresponding to a first fingerprint with second data elements from the second reporting data corresponding to the first fingerprint.

### Supplemental Note 15

A non-transitory computer readable medium configured to store instructions thereon. The instructions are configured to cause a processor to perform operations including receiving first reporting data associated with a master node for a first group of users. The instructions are configured to cause a processor to perform operations including receiving second reporting data associated with a secondary node for a second group of users. The instructions are configured to cause a processor to perform operations including determining whether an interface link between the master node and the secondary node has been established. The instructions are configured to cause a processor to perform operations including establishing the interface link between the master node and the secondary node, in response to a determination that the interface link is not established.

### Supplemental Note 16

The non-transitory computer readable medium of Supplemental Note 15, wherein the interface link includes an X2 interface link.

### Supplemental Note 17

The non-transitory computer readable medium of any of Supplement Note 15 or 16, wherein the first reporting data includes Long Term Evolution (LTE) or fourth generation (4G) measurement data and the second reporting data includes fifth generation (5G) measurement data.

### Supplemental Note 18

The non-transitory computer readable medium of any of Supplemental Notes 15-17, wherein the instructions are configured to cause a processor to perform operations including: determining, using an unsupervised machine learning model, one or more X2 link opportunities.

### Supplemental Note 19

The non-transitory computer readable medium of any of Supplemental Notes 15-18, wherein the instructions are configured to cause a processor to perform operations including: creating a fingerprint to uniquely identify data in the first reporting data.

### Supplemental Note 20

The non-transitory computer readable medium of any of Supplemental Notes 15-19, wherein the instructions are configured to cause a processor to perform operations including: comparing first data elements from the first reporting data corresponding to a first fingerprint with second data elements from the second reporting data corresponding to the first fingerprint.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system comprising:
a non-transitory computer readable medium configured to store instructions thereon; and
a processor connected to the non-transitory computer readable medium, wherein the processor is configured to execute the instructions for:
receiving first reporting data associated with a master node for a first group of users;
receiving second reporting data associated with a secondary node for a second group of users;
determining whether an interface link between the master node and the secondary node has been established; and
establishing the interface link between the master node and the secondary node, in response to a determination that the interface link is not established.

2. The system of claim 1, wherein the interface link comprises an X2 interface link.

3. The system of claim 1, wherein the first reporting data includes Long Term Evolution (LTE) or fourth generation (4G) measurement data and the second reporting data comprises fifth generation (5G) measurement data.

4. The system of claim 1, wherein the processor is further configured to execute the instructions for:
determining, using an unsupervised machine learning model, one or more X2 link opportunities.

5. The system of claim 1, wherein the processor is further configured to execute the instructions for:
creating a fingerprint to uniquely identify data in the first reporting data.

6. The system of claim 4, wherein the master node is capable of providing service for a first coverage area, and the secondary node is capable of providing service for a second coverage area within the first coverage area.

7. The system of claim 1, wherein the processor is further configured to execute the instructions for:
comparing first data elements from the first reporting data corresponding to a first fingerprint with second data elements from the second reporting data corresponding to the first fingerprint.

8. A method, the method comprising:
receiving first reporting data associated with a master node for a first group of users;
receiving second reporting data associated with a secondary node for a second group of users;
determining whether an interface link between the master node and the secondary node has been established; and
establishing the interface link between the master node and the secondary node, in response to a determination that the interface link is not established.

9. The method of claim 8, wherein the interface link comprises an X2 interface link.

10. The method of claim 8, wherein the first reporting data includes Long Term Evolution (LTE) or fourth generation (4G) measurement data and the second reporting data comprises fifth generation (5G) measurement data.

11. The method of claim 8, further comprising:
determining, using an unsupervised machine learning model, one or more X2 link opportunities.

12. The method of claim 8, further comprising:
creating a fingerprint to uniquely identify data in the first reporting data.

13. The method of claim 11, wherein the master node is capable of providing service for a first coverage area, and the secondary node is capable of providing service for a second coverage area within the first coverage area.

14. The method of claim 8, further comprising:
comparing first data elements from the first reporting data corresponding to a first fingerprint with second data elements from the second reporting data corresponding to the first fingerprint.

15. A non-transitory computer readable medium configured to store instructions thereon, wherein the instructions are configured to cause a processor to perform operations comprising:
receiving first reporting data associated with a master node for a first group of users;
receiving second reporting data associated with a secondary node for a second group of users;
determining whether an interface link between the master node and the secondary node has been established; and
establishing the interface link between the master node and the secondary node, in response to a determination that the interface link is not established.

16. The non-transitory computer readable medium of claim 15, wherein the interface link comprises an X2 interface link.

17. The non-transitory computer readable medium of claim 15, wherein the first reporting data includes Long Term Evolution (LTE) or fourth generation (4G) measurement data and the second reporting data comprises fifth generation (5G) measurement data.

18. The non-transitory computer readable medium of claim 15, wherein the instructions are configured to cause a processor to perform operations comprising:
determining, using an unsupervised machine learning model, one or more X2 link opportunities.

19. The non-transitory computer readable medium of claim 15, wherein the instructions are configured to cause a processor to perform operations comprising:
creating a fingerprint to uniquely identify data in the first reporting data.

20. The non-transitory computer readable medium of claim 15, wherein the instructions are configured to cause a processor to perform operations comprising:
comparing first data elements from the first reporting data corresponding to a first fingerprint with second data elements from the second reporting data corresponding to the first fingerprint.
